(19) United States
(12) Patent Application Publication
(10) Pub. No.: US 2004/0088700 A1
(43) Pub. Date: May 6, 2004

(54) System and method for automatically installing software on client computers via a network

(76) Inventors: Chung-I Lee, Tu-Chen (TW); Chien-Fa Yeh, Tu-Chen (TW); Xin Cao, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/286,199

(22) Filed: Oct. 31, 2002

(51) Int. Cl. G06F 9/445; G06F 9/44

(52) U.S. Cl. 717/178; 717/173

(57) ABSTRACT

A system for automatically installing software on client computers is implemented in a client-server model that comprises a server (1), a plurality of client computers (3), and a communications network (2) linking the server and the client computers. The system includes a database (10) for storing setup programs of software; a first application (11) installed in the server for inputting setup programs in and retrieving setup programs from the database, and a second application (31) installed in each client computer for receiving setup programs and installing software. When the client computers log in the domain of a Local Area Network, the software installing system automatically checks software installed in the client computers against software stored in the server, and installs software in client computers that do not already have the software installed therein.

### BACKGROUND OF THE INVENTION

1. Field of the Invention

This invention relates to systems and methods for automatically installing software on client computers, and more particularly to systems and methods which automatically check software installed in client computers against software stored in a server, and install designated software in the client computers accordingly.

2. Description of Related Art

Nowadays, most enterprises construct their electronic information systems in a client-server model. The model comprises at least one server, a plurality of client computers, and a Local Area Network (LAN) enabling data interchange between the server and the client computers. An authorized client computer can visit the server, and upload data to or download data from the server via the Local Area Network. Additionally, the client computers can visit external information systems via the server.

Normally, a group of client computers is required to have some common software installed therein. Conventionally, a system administrator uploads setup programs of required software to the server, and notifies users of the client computers to download the setup programs from a designated directory. However, the users of the client computers may be unfamiliar with computer applications, and installation of the software can easily fail. In addition, installation of the software by the users of the client computers is unduly time-consuming for the users.

U.S. Pat. No. 6,289,510 discloses an online program-updating system for automatically updating software installed in client computers via networks. The system compares version numbers of the software installed in client computers with software stored in a server. If the version numbers are different, the setup program of the old version is wholly replaced by the setup program of the new version. The client computers reinstall the software of the new version to replace the software of the old version. However, replacement of the old version and reinstallation of the software are unduly time-consuming and occupy too many resources.

Accordingly, what is needed is a new system and method which can solve the abovementioned problems.

### SUMMARY OF THE INVENTION

A primary object of the present invention is to provide a system which automatically checks software installed in client computers against software stored in a server, and which automatically installs designated software in the client computers.

Another object of the present invention is to provide a method which automatically checks software installed in client computers against software stored in a server, and which automatically installs designated software in the client computers.

To achieve the above-mentioned primary object, a system of the present invention for automatically installing software on client computers is provided. The system is implemented in a client-server model that comprises a server, a plurality of client computers, and a communications network linking the server and the client computers. The system comprises a database for storing setup programs of software; a first application installed in the server for inputting setup programs in and retrieving setup programs from the database, and a second application installed in each client computer for receiving setup programs and installing software. The first application comprises a software managing module for managing setup programs stored in the database, a system response module for providing responses to requests sent from the client computers, a system testing module for testing software installed in the client computers, and a software download module for downloading setup programs to designated client computers. The second application comprises a software receiving module for receiving setup programs sent from the server, and a software setup module for installing software on the respective client computer.

To achieve the other above-mentioned object, a method of the present invention for automatically installing software on a client computer comprises the following steps: receiving a software setup program input by an administrator; storing the software setup program in a database; receiving a login request sent from the client computer; checking a login authorization of the client computer; checking software installed in the client computer; downloading the software setup program to the client computer when a corresponding item of software has not been installed in the client computer; and invoking the software setup program in the client computer.

Other objects, advantages and novel features of the present invention will be drawn from the following detailed description of preferred embodiments of the present invention with attached drawings, in which:

### BRIEF DESCRIPTION OF THE DRAWINGS

FIG. 1 illustrates a framework of hardware of a system for automatically installing software on client computers via a network, according to a preferred embodiment of the present invention;

FIG. 2 is a block diagram showing main function modules of a first application of a server of the system of FIG. 1;

FIG. 3 is a block diagram showing main function modules of a second application of any one of client computers of the system of FIG. 1;

FIG. 4 is a flowchart of a method for the server to implement the system of FIG. 1; and

FIG. 5 is a flowchart of a method for any one of the client computers to implement the system of FIG. 1.

### DETAILED DESCRIPTION OF THE INVENTION

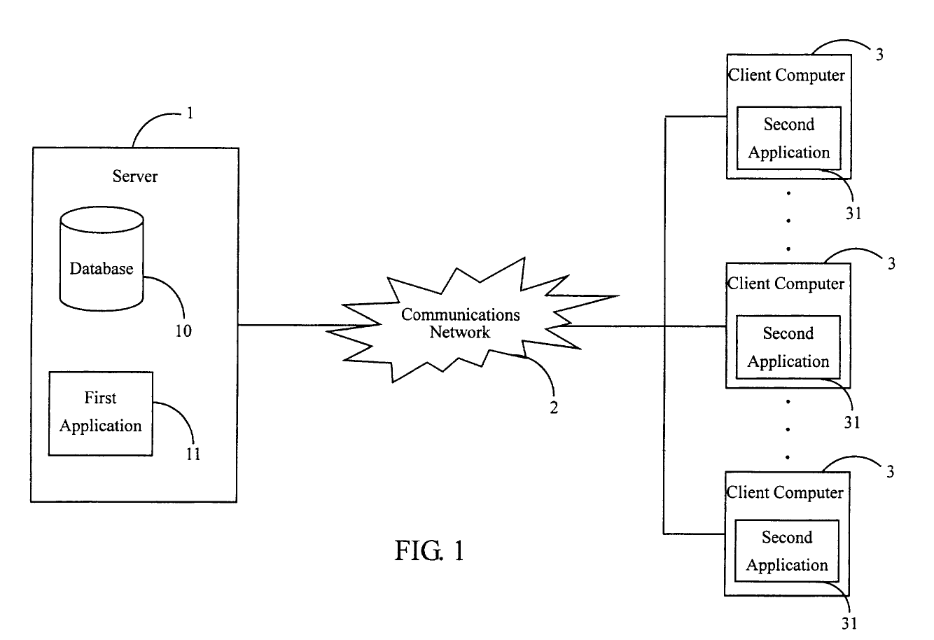

FIG. 1 illustrates a framework of hardware of a system for automatically installing software on client computers via a network, according to a preferred embodiment of the present invention. The system is implemented in a client-server model. As shown in FIG. 1, a server 1 comprises a database 10 for storing setup programs of software, and a first application 11 for installing software on client computers 3. A plurality of the client computers 3 is connected to the server 1 via a communications network 2. The communications network 2 can be the Internet, an intranet, or a Local Area Network (LAN). Each client computer 3 comprises a second application 31 for downloading and installing software from the server 1.

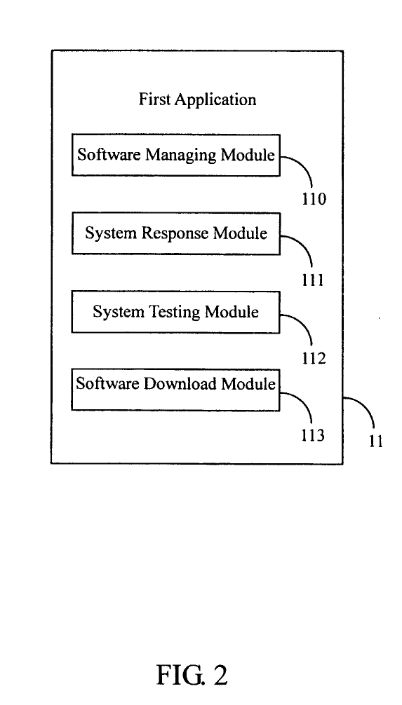

FIG. 2 is a block diagram showing main function modules of the first application 11 of the server 1. The first application 11 comprises a software managing module 110 for managing setup programs of software stored in the database 10, a system response module 111 for providing responses to requests from the client computers 3, a system testing module 112 for testing software installed in the client computers 3, and a software download module 113 for downloading setup programs of software to designated client computers 3.

The software managing module 110 receives new software input by a system administrator, and stores the new software in the database 10. If there is a new version of the software, the old version is replaced by the updated programs input by the system administrator. Some add-on programs of the software may also be added to the original programs of the software via the software managing module 110. The software managing module 110 also defines an installation authorization for each item of software. Each item of software is only installed in designated client computers 3. The client computers 3 may be divided into several groups that are respectively authorized to receive different items of software.

The system response module 111 is for providing responses to requests sent from the client computers 3. For example, when a client computer 3 connected to the server 1 via a Local Area Network (LAN) starts to run, or when a client computer 3 logs in the domain of the Local Area Network, the server 1 receives a login request from the client computer 3 and provides a response via the system response module 111. The system response module 111 checks whether the client computer 3 is authorized to log in the domain. Only authorized client computers 3 can visit the server 1 via the communications network 2.

The system testing module 112 is for testing the software installed in the client computers 3. When a client computer 3 is authorized to log in the local domain, the system testing module 112 checks whether the software installed on the client computer 3 corresponds with the software authorized to be installed on the client computer 3.

The software download module 113 is for downloading programs to the client computers 3. If authorized software is not installed on the designated client computers 3, the setup program of the software is automatically downloaded to the client computers 3. Additionally, if the version of the software installed on the client computers 3 is different to the one stored in the server 1, the software installed on the client computer 3 is automatically updated.

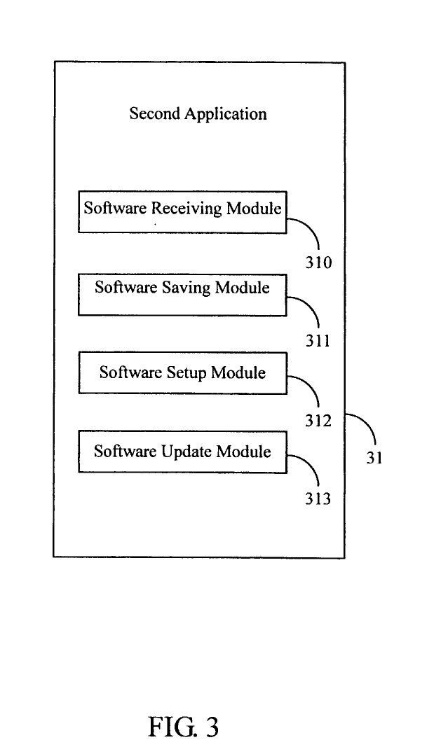

FIG. 3 is a block diagram showing main function modules of the second application 31 of any one of the client computers 3. The second application 31 comprises a software receiving module 310 for receiving setup programs sent by the server 1, a software saving module 311 for temporarily saving the setup programs in the client computer 3, a software setup module 312 for installing software on the client computer 3, and a software update module 313 for updating old versions of software.

For example, when the client computer 3 is authorized to log in a local domain, the server 1 checks whether the software installed in the client computer 3 corresponds with the software stored in the server 1. If a new item of software is not installed in the client computer 3, the software receiving module 310 receives the setup program of said software sent by the server 1. The setup program of said software is temporarily saved in a cache (not shown) of the client computer 3 by the software saving module 311. The software setup module 312 then sets up said software by executing the setup program of said software saved in the cache.

If there is an add-on program to be installed in the original program of the software, the software update module 313 is invoked to install the add-on program in the original program.

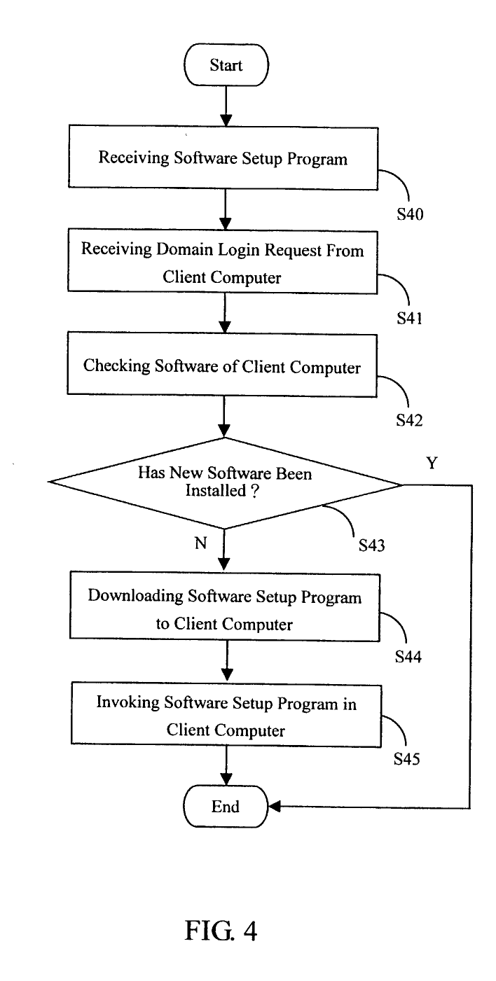

FIG. 4 is a flowchart of a method for the server 1 to implement the system for automatically installing software. In step S40, the server 1 receives a software setup program input by the administrator. The software setup program is stored in the database 10. When new software is input to the server 1 and distributed to the client computers 3, the administrator sets various authorizations for the various client computers 3. The client computers 3 may be divided into several groups, each group having a different level of authorization. In step S41, the server 1 receives a domain login request from a client computer 3. If the client computer 3 is authorized to log in, in step S42, the server 1 checks software installed in the client computer 3. In step S43, the server 1 determines whether the new software has been installed in the client computer 3. If the new software has been installed in the client computer 3, the procedure is ended. If the new software has not been installed in the client computer 3, in step S44, the server 1 downloads the setup program of the software to the client computer 3. In step S45, the server 1 invokes the setup program in the client computer 3 to set up the software.

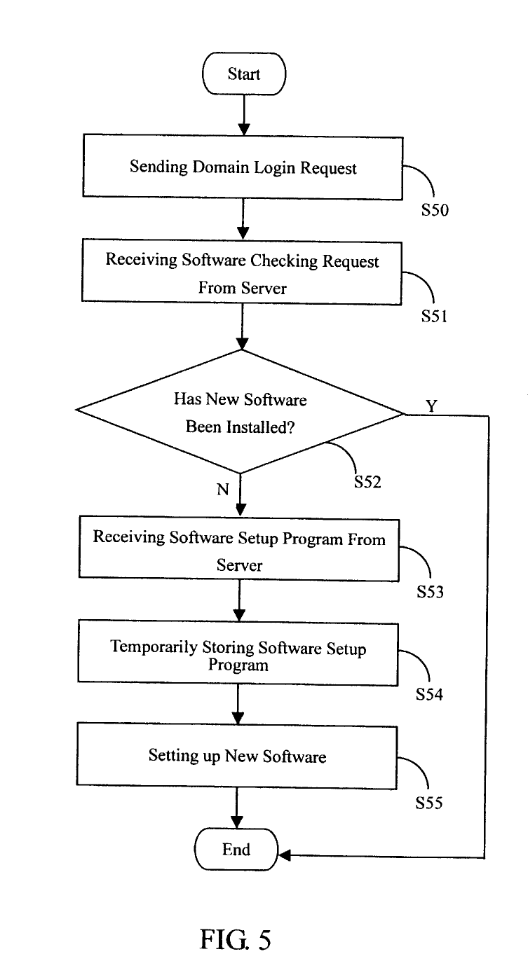

FIG. 5 is a flowchart of a method for any one of the client computers 3 to implement the system for automatically installing software. In step S50, the client computer 3 logs in the local domain, and sends a domain login request to the server 1. If the client computer 3 is authorized to log in the local domain, in step 51, the client computer 3 receives a software checking request from the server 1. In step S52, the client computer 3 determines whether the new software has been installed in itself. If the new software has been installed in the client computer 3, the procedure is ended. If the new software has not been installed in the client computer 3, in step S53, the client computer 3 receives the software setup program sent from the server 1. In step S54, the setup program is temporarily stored in the cache of the client computer 3. In step S55, the setup program is invoked and the software is installed in the client computer 3.

The preferred embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for automatically installing software on client computers via a network, the system being implemented in a client-server model that comprises a server, a plurality of client computers and a communications network linking the server and the client computers, the system comprising:
a database for storing setup programs of software;
a first application installed in the server, the first application providing functions of inputting setup programs in and retrieving setup programs from the database, the first application comprising a software managing module for managing setup programs stored in the database, a system response module for providing responses to requests from the client computers, a system testing module for testing software installed in the client computers, and a software download module for downloading setup programs to designated client computers; and
a second application installed in each of the client computers, the second application comprising a software receiving module for receiving setup programs sent from the server, and a software setup module for installing software on the respective client computer.

2. The system as claimed in claim 1, wherein the second application further comprises a software saving module for temporarily saving setup programs in the respective client computer.

3. The system as claimed in claim 1, wherein the second application further comprises a software update module for updating old versions of software.

4. The system as claimed in claim 1, wherein the database is installed in the server.

5. A method for automatically installing software on a client computer, the method comprising the steps of:
receiving a login request sent from the client computer;
checking software installed in the client computer;
downloading a software setup program to the client computer when a corresponding item of software has not been installed in the client computer; and
invoking the software setup program in the client computer.

6. The method as claimed in claim 5, further comprising the step of: receiving a software setup program input by an administrator.

7. The method as claimed in claim 6, further comprising the step of: storing the software setup program in a database.

8. The method as claimed in claim 5, further comprising the step of: checking a login authorization of the client computer.

9. The method as claimed in claim 5, further comprising the step of; downloading an add-on program to the client computer when the add-on program has not been installed in the client computer.

10. A method for a client computer automatically installing software downloaded from a server, the method comprising the steps of:
sending a login request to log in a communications network;
receiving a software checking request from the server for checking software installed in the client computer;
receiving a software setup program sent from the server when a corresponding item of software has not been installed in the client computer; and
installing the software by invoking the software setup program.

11. The method as claimed in claim 10, further comprising the step of: storing the software setup program temporarily in the client computer.

12. A method of automatically installing software downloaded from a server unto a client computer, the method comprising the steps of:
providing a server with updated software thereof;
sending software checking request from the server to the client computer every time said client computer is logged in;
sending a software set up program from the server to the client computer if no software in the client computer is exactly matched with said software checking request; and
automatically installing said software in the client computer by invoking said transferred software set up program.
